(19) United States
(12) Patent Application Publication
(10) Pub. No.: US 2023/0150460 A1
(43) Pub. Date: May 18, 2023

(54) DRIVING ASSISTANCE DEVICE AND DRIVING ASSISTANCE METHOD

(71) Applicant: Isuzu Motors Limited, Tokyo (JP)

(72) Inventors: Wasantha OSHITA, Fujisawa-shi, Kanagawa (JP); Masaichi TAKAHASHI, Fujisawa-shi, Kanagawa (JP); Shinichiro FUKAZAWA, Fujisawa-shi, Kanagawa (JP)

(73) Assignee: Isuzu Motors Limited, Tokyo (JP)

(21) Appl. No.: 17/801,540

(22) PCT Filed: Feb. 26, 2021
(86) PCT No.: PCT/JP2021/007479

§ 371 Date: Aug. 23, 2022

(30) Foreign Application Priority Data
Feb. 28, 2020 (JP) 2020-033763

(51) Int. Cl. B60T 7/12

(52) U.S. Cl. CPC B60T 7/12; B60T 2210/32

(57) ABSTRACT

This driving assistance device comprises: an inter-vehicle distance detection unit for detecting the inter-vehicle distance from a host vehicle to a preceding vehicle; a speed detection unit for detecting the speed of the preceding vehicle; a deceleration detection unit for detecting the deceleration of the preceding vehicle; a preceding-vehicle braking distance estimation unit for estimating the braking distance of the preceding vehicle on the basis of the detected speed and deceleration; a target braking distance calculation unit for calculating a target braking distance of the host vehicle on the basis of the inter-vehicle distance to the preceding vehicle and the braking distance of the preceding vehicle; and a braking control unit for controlling the braking of the host vehicle on the basis of the target braking distance.

### TECHNICAL FIELD

The present disclosure relates to a driving assistance apparatus that assists the driving of a vehicle and a driving assistance method of assisting the driving of the vehicle.

### BACKGROUND ART

In recent years, as one technology of assisting the driving of a vehicle, adaptive cruise control (hereinafter referred to as “ACC”) has been gathering attention (for example, see Patent Literature (hereinafter, referred to as PTL 1)). The ACC is a technology of obtaining the vehicle speed of a vehicle, the relative speed of a leading car with respect to the vehicle, the inter-vehicle distance between the vehicle and the leading car, and the like, and controlling a driving system and a braking system of the vehicle such that the vehicle speed and the inter-vehicle distance from the leading car are maintained to be constant.

### CITATION LIST

### Patent Literature

PTL 1

Japanese Patent Application Laid-Open No. HEI 7-17295

### SUMMARY OF INVENTION

### Technical Problem

A case where another car cuts into a place between a leading car serving as a target and the own car during the execution of the ACC is supposed. In this case, the target of the ACC changes to the other car, and the inter-vehicle distance suddenly becomes shorter as compared to a target inter-vehicle distance. At this time, the own car tries to increase the inter-vehicle distance from the other car to the target inter-vehicle distance by the ACC, and hence a rapid deceleration is performed. In particular, when the other car cuts in while decelerating, the degree of the rapid deceleration becomes even more greater.

The present disclosure has been made in view of the abovementioned points and provides a driving assistance apparatus and a driving assistance method capable of suitably ensuring the inter-vehicle distance from a leading car without performing an unnecessary rapid deceleration.

### Solution to Problem

One aspect of a driving assistance apparatus of the present disclosure is an apparatus that assists driving of a vehicle, the driving assistance apparatus comprising:

an inter-vehicle-distance detection section that detects an inter-vehicle distance from own car to a leading car;

a speed detection section that detects a speed of the leading car;

a deceleration-speed detection section that detects a deceleration speed of the leading car;

a leading-car braking-distance estimation section that estimates a braking distance of the leading car on basis of the detected speed and deceleration speed;

a target-braking-distance calculation section that calculates a target braking distance of the own car on basis of the inter-vehicle distance from the leading car and the braking distance of the leading car; and

a braking control section that controls braking of the own car on basis of the target braking distance.

One aspect of a driving assistance method of the present disclosure is a method of assisting driving of a vehicle, the driving assistance method comprising: detecting an inter-vehicle distance from own car to a leading car;

detecting a speed of the leading car;

detecting a deceleration speed of the leading car;

estimating a braking distance of the leading car on basis of the speed and the deceleration speed of the leading car;

calculating a target braking distance of the own car on basis of the inter-vehicle distance from the leading car and the braking distance of the leading car; and

controlling braking of the own car on basis of the target braking distance.

### Advantageous Effects of Invention

According to the present disclosure, it is possible to suitably ensure the inter-vehicle distance from the leading car without performing an unnecessary rapid deceleration.

### BRIEF DESCRIPTION OF DRAWINGS

FIG. 1 is an external view illustrating an example of a vehicle to which a driving assistance apparatus according to an embodiment is applied;

FIG. 2 is a block diagram illustrating the configuration of the vehicle of the embodiment;

FIG. 3 is a view illustrating a state in which a cutting-in car cuts into a place ahead of own car;

FIG. 4 is a view illustrating a state of deceleration control when cutting-in occurs at the time of ACC according to the embodiment;

FIG. 5 is a block diagram illustrating the configuration of the driving assistance apparatus of the embodiment; and

FIG. 6 is a flowchart provided for the description of the operation of the driving assistance apparatus of the embodiment.

### DESCRIPTION OF EMBODIMENTS

One embodiment of the present invention is described in detail below with reference to the accompanying drawings.

### <1> Configuration of Vehicle

First, the configuration of a vehicle including a driving assistance apparatus according to one embodiment of the present disclosure is described.

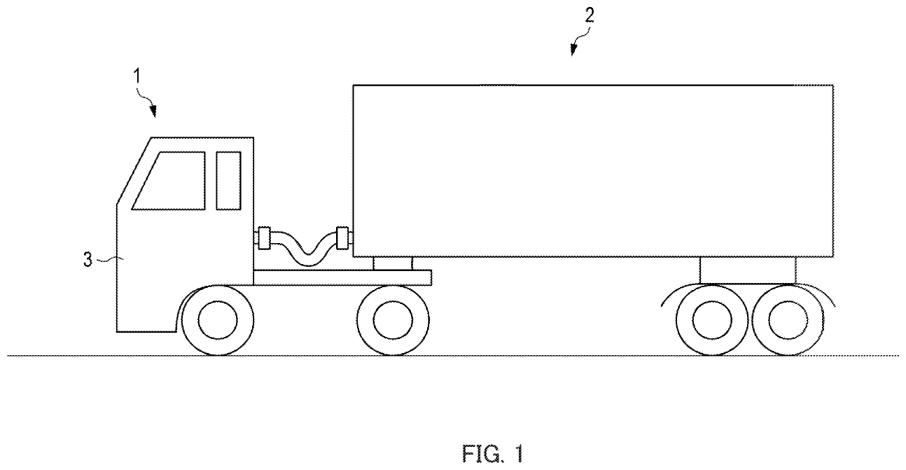

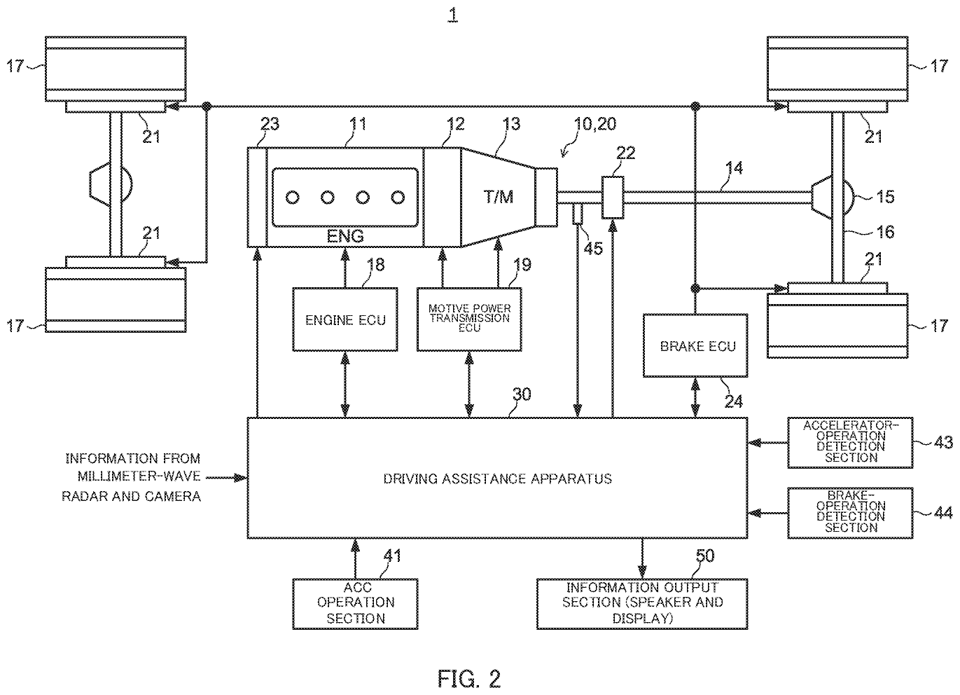

FIG. 1 is an external view illustrating an example of vehicle 1 to which a driving assistance apparatus according to the present embodiment is applied. FIG. 2 is a block diagram illustrating the configuration of vehicle 1. Illustration and description are made by focusing on parts relating to the driving assistance apparatus.

As illustrated in FIG. 1, vehicle 1 is a tractor (traction vehicle) capable of towing trailer 2 as a result of coupling trailer 2 to the tractor. Vehicle 1 has vehicle main-body portion 3 including a power system such as an engine and driving wheels and a driver's seat, and trailer 2 coupled to vehicle main-body portion 3.

As illustrated in FIG. 2, vehicle 1 has driving system 10 that causes vehicle 1 to travel, braking system 20 that decelerates vehicle 1, driving assistance apparatus 30 that assists the driving of vehicle 1 by a driver, and the like.

Driving system 10 has engine 11, clutch 12, transmission 13, propeller shaft 14, differential gear 15, drive shaft 16, wheels 17, engine ECU 18, and motive power transmission ECU 19.

Engine ECU 18 and motive power transmission ECU 19 are connected to driving assistance apparatus 30 by an in-vehicle network such as a controller area network (CAN) and are able to transmit and receive necessary data and control signals to and from each other. Engine ECU 18 controls the output of engine 11 in accordance with a drive command from driving assistance apparatus 30. Motive power transmission ECU 19 controls the connection and disconnection of clutch 12 and the speed change of transmission 13 in accordance with a drive command from driving assistance apparatus 30.

The motive power of engine 11 is transmitted to transmission 13 via clutch 12. The motive power transmitted to transmission 13 is further transmitted to wheels 17 via propeller shaft 14, differential gear 15, and drive shaft 16. As a result, the motive power of engine 11 is transmitted to wheels 17, and vehicle 1 travels.

Braking system 20 has service brakes 21, auxiliary brakes 22, 23, a parking brake (not shown), and brake ECU 24.

Service brake 21 is a brake that is generally referred to as a main brake, a friction brake, a foot brake, a foundation brake, or the like. Service brake 21 is a drum brake that obtains braking force by pressing a brake lining against the inner side of a drum that rotates with wheel 17, for example.

Auxiliary brake 22 is a retarder (hereinafter referred to as “retarder 22”) that obtains braking force by directly giving load to the rotation of propeller shaft 14, and is an electromagnetic retarder, for example. Auxiliary brake 23 is an exhaust brake (hereinafter referred to as “exhaust brake 23”) that increases an effect of an engine brake with use of rotational resistance of the engine. By providing retarder 22 and exhaust brake 23, the braking force can be increased, and the frequency of usage of service brakes 21 is reduced. Therefore, the wear-out of brake lining and the like can be suppressed.

Brake ECU 24 is connected to driving assistance apparatus 30 by an in-vehicle network such as a CAN and is able to transmit and receive necessary data and control signals to and from each other. Brake ECU 24 controls the braking force of service brakes 21 (the brake fluid pressure of wheel cylinders of wheels 17) in accordance with a braking command from driving assistance apparatus 30.

The braking operation of service brakes 21 is controlled by driving assistance apparatus 30 and brake ECU 24. The braking operation of retarder 22 and exhaust brake 23 is controlled by on/off by driving assistance apparatus 30. The braking force of retarder 22 and exhaust brake 23 is substantially fixed. Therefore, when a desired braking force is to be accurately generated, service brakes 21 that can fine-adjust the braking force are suitable.

Information from a millimeter-wave radar and a camera is input to driving assistance apparatus 30. Information from the millimeter-wave radar and the camera is information indicating the traffic situation and the road situation ahead of the vehicle. Driving assistance apparatus 30 has ACC operation section 41, accelerator-operation detection section 43, brake-operation detection section 44, and the like.

Driving assistance apparatus 30 forms control signals for controlling the operation of driving system 10 and braking system 20. Specifically, driving assistance apparatus 30 obtains a target acceleration/deceleration speed for realizing ACC and outputs the target acceleration/deceleration speed to engine ECU 18, motive power transmission ECU 19, and brake ECU 24, as appropriate.

Although not shown, each of engine ECU 18, motive power transmission ECU 19, brake ECU 24, and driving assistance apparatus 30 has a central processing unit (CPU), a storage medium such as a read only memory (ROM) in which a control program is stored, a working memory such as a random access memory (RAM), and a communication circuit, for example. In this case, for example, the functions of sections described below constituting driving assistance apparatus 30 are realized by executing control programs by the CPU. All or some of engine ECU 18, motive power transmission ECU 19, brake ECU 24, and driving assistance apparatus 30 may be integrated.

ACC operation section 41 includes an ACC ON/OFF switch for activating and removing the ACC. ACC operation section 41 includes a setting switch for performing various settings of the ACC. A driver can set a target inter-vehicle distance and a target own-vehicle speed, for example, by operating the setting switch. Those switches may be realized by a user interface displayed on a display with a touch screen.

Accelerator-operation detection section 43 detects the depression amount of an accelerator pedal and outputs the detection result to driving assistance apparatus 30. Driving assistance apparatus 30 transmits drive commands to engine ECU 18 and motive power transmission ECU 19 on the basis of the depression amount of the accelerator pedal.

Brake-operation detection section 44 detects the depression amount of a brake pedal for operating service brakes 21. Brake-operation detection section 44 detects whether an auxiliary brake lever that causes retarder 22 or exhaust brake 23 to operate has been operated. Brake-operation detection section 44 outputs the detection result relating to the brake pedal and the auxiliary brake lever to driving assistance apparatus 30. Driving assistance apparatus 30 transmits a braking command to brake ECU 24 on the basis of the depression amount of the brake pedal. Driving assistance apparatus 30 controls the ON/OFF operation of retarder 22 or exhaust brake 23 on the basis of the operation of the auxiliary brake lever.

Driving assistance apparatus 30 outputs various information relating to traveling and the ACC from information output section 50. For example, display and sound indicating that the ACC is active or the ACC is removed are output from information output section 50.

### <2> Deceleration Control when Cutting-In Occurs at Time of ACC

Next, deceleration control when cutting-in occurs at the time of the ACC according to the present embodiment is described.

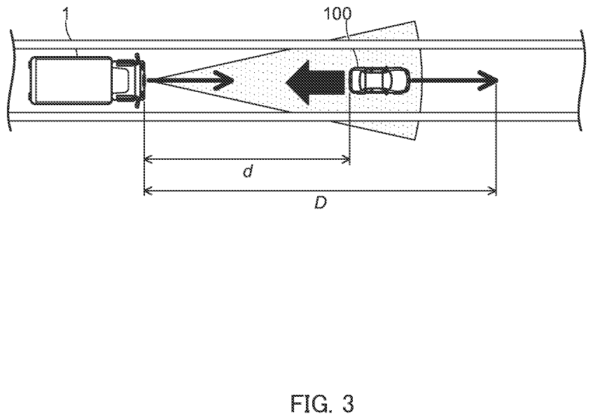

FIG. 3 is a view illustrating a state in which cutting-in car 100 cuts into a place ahead of own car 1. Cutting-in car 100 travels while decelerating. The expression of “cutting-in” in the present embodiment means that a vehicle different from a vehicle serving as a target enters a position at inter-vehicle distance d that is shorter than target inter-vehicle distance D of the ACC in the same lane as own car 1.

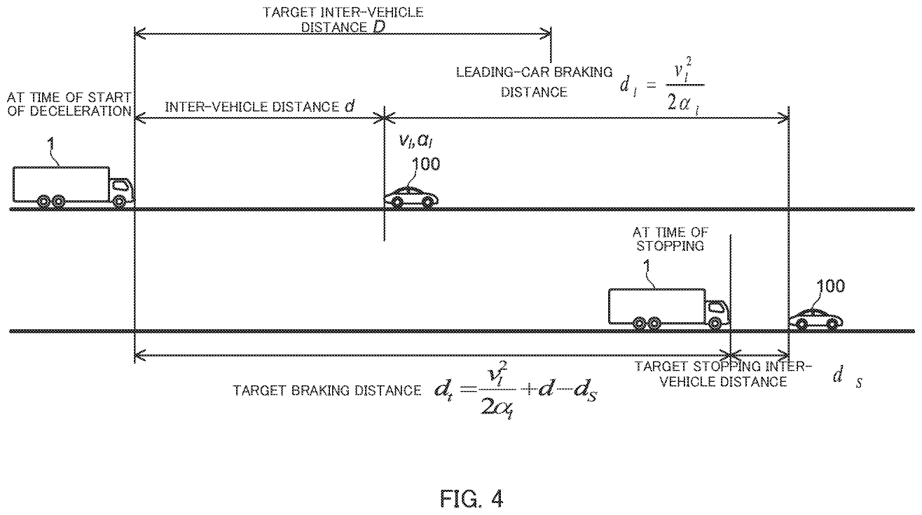

FIG. 4 is a view illustrating a state of the deceleration control when cutting-in occurs at the time of the ACC according to the embodiment.

When cutting-in car 100 enters a position at inter-vehicle distance d, own car 1 detects speed v₁ and deceleration speed α₁ of cutting-in car 100. Own car 1 estimates braking distance d₁ of cutting-in car 100 by the following expression with use of speed v₁ and deceleration speed α₁ of cutting-in car 100.

d₁=(v₁²)/(2α₁) (Expression 1)

Next, own car 1 calculates target braking distance dₜ of own car 1. Target braking distance dₜ is a braking distance required for the vehicle to stop at a position behind a vehicle-stop position of cutting-in car 100 by target inter-vehicle stopping distance dₛ. Target braking distance dₜ can be calculated by the following expression.

dₜ=(v₁²)/(2α₁)+d−dₛ (Expression 2)

Own car 1 controls the braking of the own car such that own car 1 stops at a position at a target braking distance.

### <3> Configuration of Driving Assistance Apparatus

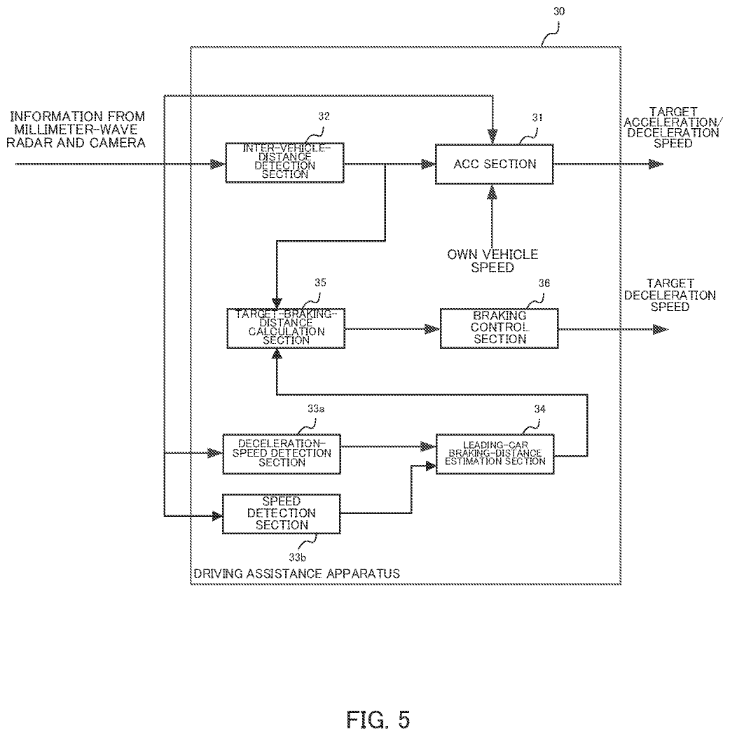

FIG. 5 is block diagram illustrating the configuration of driving assistance apparatus 30 of the present embodiment.

Driving assistance apparatus 30 has ACC section 31, inter-vehicle-distance detection section 32, deceleration-speed detection section 33a, speed detection section 33b, leading-car braking-distance estimation section 34, target-braking-distance calculation section 35, and braking control section 36.

ACC section 31 realizes automatic following control by outputting a target acceleration/deceleration speed for causing the own car to follow a leading car on the basis of the relative speed and the inter-vehicle distance between the own car and the leading car. When there are no leading cars, ACC section 31 realizes constant speed traveling control by outputting a target acceleration speed for causing the speed of the own car to be a set certain speed.

Automatic-following traveling control is control that operates driving system 10 and braking system 20 such that the inter-vehicle distance is within a predetermined target range and the relative speed approaches zero when a leading car is present in a predetermined range. The constant-speed traveling control is control that operates driving system 10 and braking system 20 such that the traveling speed of vehicle 1 approaches a predetermined target value when there are no leading cars in a predetermined range.

Inter-vehicle-distance detection section 32 measures (detects) inter-vehicle distance d between own car 1 and the leading car on the basis of information on a place ahead of own car 1 obtained by the millimeter-wave radar, the camera, and the like, and outputs the measurement result to ACC section 31 and target-braking-distance calculation section 35. Inter-vehicle-distance detection section 32 may measure the inter-vehicle distance d on the basis of information from other sensors such as a laser radar.

Deceleration-speed detection section 33a detects deceleration speed al of the leading car (cutting-in car 100) on the basis of information obtained by the millimeter-wave radar. Specifically, the speed of cutting-in car 100 can be measured two times by the millimeter-wave radar, and deceleration speed al can be calculated on the basis of the difference thereof.

Speed detection section 33b detects speed v₁ of the leading car (cutting-in car 100) on the basis of information obtained by the millimeter-wave radar. Deceleration speed α₁ and speed v₁ of the leading car (cutting-in car 100) are detected every 50 [milliseconds], for example.

Leading-car braking-distance estimation section 34 estimates braking distance d₁ of the leading car (cutting-in car 100) on the basis of detected speed v₁ and deceleration speed α₁. Specifically, braking distance d₁ is estimated by abovementioned expression 1.

Target-braking-distance calculation section 35 calculates target braking distance dₜ of own car 1 on the basis of inter-vehicle distance d from the leading car (cutting-in car 100) and braking distance d₁ of the leading car (cutting-in car 100). Specifically, target braking distance dₜ is calculated by abovementioned expression 2.

Braking control section 36 controls the braking of the own car such that own car 1 stops at a position at target braking distance dₜ. Specifically, braking control section 36 outputs a target deceleration speed with which own car 1 stops at a position at target braking distance dₜ.

### <4> Operation of Driving Assistance Apparatus

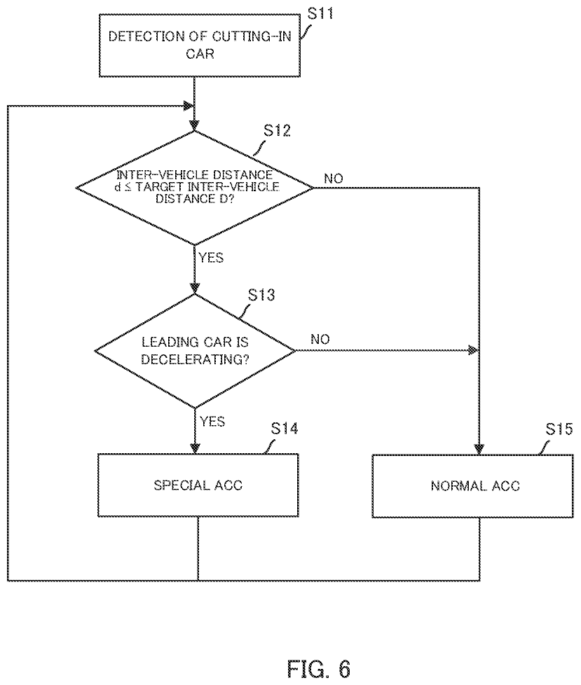

Next, an operation of driving assistance apparatus 30 is described. Driving assistance apparatus 30 of the present embodiment is particularly characterized by deceleration control at the time of the ACC. Therefore, the deceleration control when cutting-in occurs at the time of the ACC is mainly described with reference to FIG. 6.

When driving assistance apparatus 30 detects cutting-in car 100 in Step S11, driving assistance apparatus 30 transitions to Step 12. Cutting-in car 100 can be detected by information from the camera and the like.

Driving assistance apparatus 30 determines whether inter-vehicle distance d from the leading car (cutting-in car 100) is equal to or less than predetermined threshold value (target inter-vehicle distance) D in Step S12 and determines whether the leading car (cutting-in car 100) is decelerating in Step S13.

When inter-vehicle distance d from the leading car (cutting-in car 100) is equal to or less than threshold value D and the leading car (cutting-in car 100) is decelerating, driving assistance apparatus 30 transitions to Step S14 and performs special ACC. The special ACC is processing as that illustrated in FIG. 4, and is processing performed by deceleration-speed detection section 33a, speed detection section 33b, leading-car braking-distance estimation section 34, target-braking-distance calculation section 35, and braking control section 36.

Meanwhile, driving assistance apparatus 30 transitions to Step S15 and performs normal ACC by ACC section 31 when inter-vehicle distance d from the leading car is greater than threshold value D or when the leading car is not decelerating. In other words, the braking of the own car is controlled such that inter-vehicle distance d from the leading car reaches target inter-vehicle distance D.

Driving assistance apparatus 30 performs the processing of Step S14 or Step S15 for a certain predetermined period of time (for example, one second), and then returns to Step S12 again and repeats similar processing. When cutting-in car 100 starts to travel at a constant speed or starts to accelerate as such processing is repeated, target inter-vehicle distance D is ensured. Therefore, the processing of Step S14 is not performed, and the processing of Step S15 is performed.

The special ACC of the present embodiment ensures the inter-vehicle distance while supposing the worst case in which cutting-in car 100 is stopped. In other words, the processing of the present embodiment is processing supposing the worst case, but the amount of time for the vehicle to stop can be ensured. Therefore, rapid deceleration can be decreased as compared to a case where inter-vehicle distance d that has become shorter by the cutting-in is increased to target inter-vehicle distance D in a rush as in the normal ACC.

### <5> Effects of Embodiment

As described above, according to the present embodiment, driving assistance apparatus 30 includes: inter-vehicle-distance detection section 32 that detects inter-vehicle distance d from own car 1 to the leading car; speed detection section 33b that detects speed v₁ of the leading car; deceleration-speed detection section 33a that detects deceleration speed α₁ of the leading car; leading-car braking-distance estimation section 34 that estimates braking distance d₁ of the leading car on the basis of detected speed v₁ and deceleration speed α₁; target-braking-distance calculation section 35 that calculates target braking distance dₜ of own car 1 on the basis of inter-vehicle distance d from the leading car and braking distance d₁ of leading car 1; and braking control section 36 that controls braking of own car 1 on the basis of target braking distance dₜ.

As a result, the inter-vehicle distance from the leading car can be suitably ensured without performing an unnecessary rapid deceleration (that is, a rapid deceleration caused when inter-vehicle distance d is tried to be increased to target inter-vehicle distance D).

The abovementioned embodiment is merely an example of a realization for carrying out the present invention, and the interpretation of the technical scope of the present invention is not to be limited by those embodiments. In other words, the present invention can be carried out in various forms without departing from the gist or the main features of the present invention.

In the present embodiment, a case where vehicle 1 to which the driving assistance apparatus and method of the present invention is applied is a tractor capable of towing trailer 2 as a result of coupling trailer 2 to the tractor is described. However, the vehicle to which the present invention is applicable is not limited thereto and may be a vehicle such as a passenger car.

The present application is based on Japanese Patent Application (Japanese Patent Application No. 2020-33763) filed on Feb. 28, 2020, the entire content of which is incorporated herein by reference.

### INDUSTRIAL APPLICABILITY

The driving assistance apparatus and the driving assistance method of the present disclosure are suitable for use as a driving assistance apparatus and a driving assistance method capable of suitably ensuring the inter-vehicle distance from a leading car without performing an unnecessary rapid deceleration.

### REFERENCE SIGNS LIST

1 Vehicle (own car)
2 Trailer
3 Vehicle main-body portion
10 Driving system
11 Engine
12 Clutch
13 Transmission
14 Propeller shaft
15 Differential gear
16 Drive shaft
17 Wheel
18 Engine ECU
19 Motive power transmission ECU
20 Braking system
21 Service brake
22 Retarder
23 Exhaust brake
24 Brake ECU
30 Driving assistance apparatus
31 ACC section
32 Inter-vehicle-distance detection section
33a Deceleration-speed detection section
33b Speed detection section
34 Leading-car braking-distance estimation section
35 Target-braking-distance calculation section
36 Braking control section
41 ACC operation section
43 Accelerator-operation detection section
44 Brake-operation detection section
50 Information output section

1. A driving assistance apparatus that assists driving of a vehicle, the driving assistance apparatus comprising:
an inter-vehicle-distance detection section that detects an inter-vehicle distance from own car to a leading car;
a speed detection section that detects a speed of the leading car;
a deceleration-speed detection section that detects a deceleration speed of the leading car;
a leading-car braking-distance estimation section that estimates a braking distance of the leading car on basis of the detected speed and deceleration speed;
a target-braking-distance calculation section that calculates a target braking distance of the own car on basis of the inter-vehicle distance from the leading car and the braking distance of the leading car; and
a braking control section that controls braking of the own car on basis of the target braking distance.

2. The driving assistance apparatus according to claim 1, wherein the target braking distance of the own car is of a value smaller than a value obtained by adding the inter-vehicle distance from the leading car and the braking distance of the leading car.

3. The driving assistance apparatus according to claim 1, wherein the braking control section controls braking of the own car on basis of the target braking distance when the inter-vehicle distance from the leading car is equal to or less than a threshold value and the leading car is decelerating.

4. The driving assistance apparatus according to claim 1, wherein the braking control section:
controls braking of the own car on basis of the target braking distance when the inter-vehicle distance from the leading car is equal to or less than a threshold value and the leading car is decelerating; and
controls braking of the own car such that the inter-vehicle distance from the leading car reaches a target inter-vehicle distance when the inter-vehicle distance from the leading car is greater than the threshold value or the leading car is not decelerating.

5. A driving assistance method of assisting driving of a vehicle, the driving assistance method comprising:
detecting an inter-vehicle distance from own car to a leading car;
detecting a speed of the leading car;
detecting a deceleration speed of the leading car;
estimating a braking distance of the leading car on basis of the speed and the deceleration speed of the leading car;
calculating a target braking distance of the own car on basis of the inter-vehicle distance from the leading car and the braking distance of the leading car; and
controlling braking of the own car on basis of the target braking distance.

6. The driving assistance method according to claim 5, further comprising controlling braking of the own car on basis of the target braking distance when the inter-vehicle distance from the leading car is equal to or less than a threshold value and the leading car is decelerating.
